(19) United States
(12) Patent Application Publication
(10) Pub. No.: US 2015/0358928 A1
(43) Pub. Date: Dec. 10, 2015

(54) AUTOMATIC GAIN CONTROL FOR TIME DIVISION DUPLEX LTE

(71) Applicant: QUALCOMM INCORPORATED, San Diego, CA (US)

(72) Inventors: Ozgur DURAL, San Diego, CA (US); Soumya DAS, San Diego, CA (US); Olufunmilola O. AWONIYI-OTERI, San Diego, CA (US); Kaushik CHAKRABORTY, San Diego, CA (US)

(21) Appl. No.: 14/297,426

(22) Filed: Jun. 5, 2014

(51) Int. Cl. H04W 52/52; H04L 27/38

(52) U.S. Cl. CPC H04W 52/52; H04L 27/3809; H04W 84/12

(57) ABSTRACT

Data samples of a signal transmitted by a WWAN are captured during a first set of capture ticks for a first capture period defined by a plurality of contiguous ticks. The first set of capture ticks comprises a first subset of the plurality of contiguous ticks, and the capturing is done using a WLAN receive chain having a switchable LNA gain state. The capturing of data samples is repeated for at least one additional capture period defined by a plurality of contiguous ticks to capture data samples during at least one additional set of capture ticks comprising an additional subset of the plurality of contiguous ticks for which data samples were not previously captured. The LNA gain state of the WLAN receive chain is switched at least once over the plurality of capture periods. Gain state switching may occur a capture period, or between capture periods.

### BACKGROUND

1. Field

The present disclosure relates generally to communication systems, and more particularly, to automatic gain control (AGC) for time division duplex (TDD) Long Term Evolution (LTE) using a wireless local area network (WLAN) receive chain.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

Methods, computer program products, and apparatuses are provided for capturing a plurality of data samples over a plurality of capture periods to form continuous data including a signal of interest periodically transmitted by a wireless wide area network (WWAN). Data samples are captured during a first set of capture ticks for a first capture period defined by a plurality of contiguous ticks. The first set of capture ticks comprises a first subset of the plurality of contiguous ticks, and the capturing is done using a wireless local area network (WLAN) receive chain having a switchable LNA gain state. The capturing of data samples is repeated for at least one additional capture period defined by a plurality of contiguous ticks in order to capture data samples during at least one additional set of capture ticks comprising an additional subset of the plurality of contiguous ticks for which data samples were not previously captured. During the capturing, the LNA gain state of the WLAN receive chain is switched at least once over the plurality of capture periods. Gain state switching may occur within one or more of the capture periods, or between the capture periods.

Methods, computer program products, and apparatuses are provided for capturing a plurality of data samples during a single capture period using a WLAN receive chain, wherein the data samples include a signal of interest periodically transmitted by a WWAN. A preferred LNA gain state is selected from among a plurality of available LNA gain states for the WLAN receive chain. The plurality of gain states may be a discrete set of LNA gain states or may be a set of LNA gain states derived from energy measurements. The LNA gain state of the WLAN receive chain is set to the selected LNA gain state and data samples are captured during each of a plurality of contiguous capture ticks within a capture period. The captured data samples are processed to detect for the signal of interest.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7 is an illustration of a UE with multiple radios.

FIG. 8 is an illustration of a radio communication frame structure of a time division duplex (TDD) LTE radio frame in the time domain.

FIG. 9 is an illustration of a subframe #0 and subframe #1 of FIG. 8, showing the locations of PSS and SSS.

FIG. 10 is an illustration of a pipeline operation for deriving and setting low noise amplifier (LNA) gains states.

FIG. 11 is a flow chart of a method of capturing a plurality of data samples over multiple capture periods to form continuous data including a signal of interest periodically transmitted by a WWAN.

FIG. 12 is an example depiction of the method of FIG. 11.

FIG. 13 is an illustration of various patterns of sets of capture ticks, wherein the LNA gain state is switched during capture periods.

FIG. 14 is an illustration of sets of capture ticks for capturing a signal of interest having a periodicity of 5 ms.

FIG. 15 is an illustration of sets of capture ticks for capturing a signal of interest that is only partially captured.

FIG. 16 is an illustration of sets of capture ticks, wherein the LNA gain state is switched between capture periods.

FIG. 17 is a conceptual data flow diagram illustrating the data flow between different modules/means/components in an exemplary apparatus that implements the method of FIG. 12.

FIG. 18 is a diagram illustrating an example of a hardware implementation for an apparatus employing a processing system that implements the method of FIG. 12

FIG. 19 is a flow chart of a method of capturing a plurality of data samples during a single capture period using a WLAN receive chain, wherein the data samples include a signal of interest periodically transmitted by a WWAN.

FIGS. 20 and 21 are example depictions of the method of FIG. 19, in cases where the plurality of available LNA gain states may be limited to a discrete set of LNA gain states.

FIG. 22 is an example depiction of the method of FIG. 19, in a case where the plurality of available LNA gain states are derived from energy measurements and captured data samples are digitally compensated.

FIG. 23 is another example depiction of the method of FIG. 19, in a case where the plurality of available LNA gain states are derived from energy measurements and captured data samples are digitally compensated.

FIG. 24 is a conceptual data flow diagram illustrating the data flow between different modules/means/components in an exemplary apparatus that implements the method of FIG. 19.

FIG. 25 is a diagram illustrating an example of a hardware implementation for an apparatus employing a processing system that implements the method of FIG. 19.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

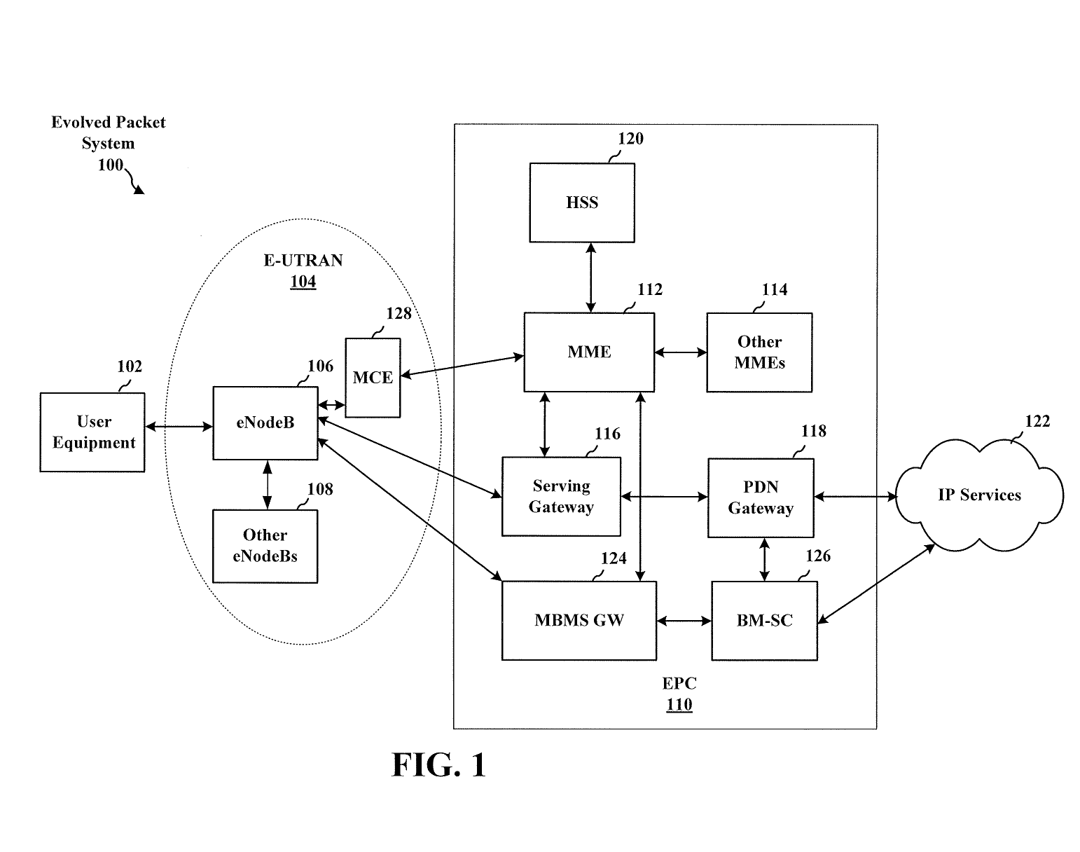

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108, and may include a Multicast Coordination Entity (MCE) 128. The eNB 106 provides user and control planes protocol terminations toward the UE 102. The eNB 106 may be connected to the other eNBs 108 via a backhaul (e.g., an X2 interface). The MCE 128 allocates time/frequency radio resources for evolved Multimedia Broadcast Multicast Service (eMBMS), and determines the radio configuration (e.g., a modulation and coding scheme (MCS)) for the eMBMS. The MCE 128 may be a separate entity or part of the eNB 106. The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 may include a

Mobility Management Entity (MME) 112, a Home Subscriber Server (HSS) 120, other MMEs 114, a Serving Gateway (SGW) 116, a Multimedia Broadcast Multicast Service (MBMS) Gateway 124, a Broadcast Multicast Service Center (BM-SC) 126, and a Packet Data Network (PDN) Gateway (PGW) 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 and the BM-SC 126 are connected to the IP Services 122. The IP Services 122 may include the Internet, an intranet, an IP Multimedia Subsystem (IMS), a PS Streaming Service (PSS), and/or other IP services. The BM-SC 126 may provide functions for MBMS user service provisioning and delivery. The BM-SC 126 may serve as an entry point for content provider MBMS transmission, may be used to authorize and initiate MBMS Bearer Services within a Public Land Mobile Network (PLMN), and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

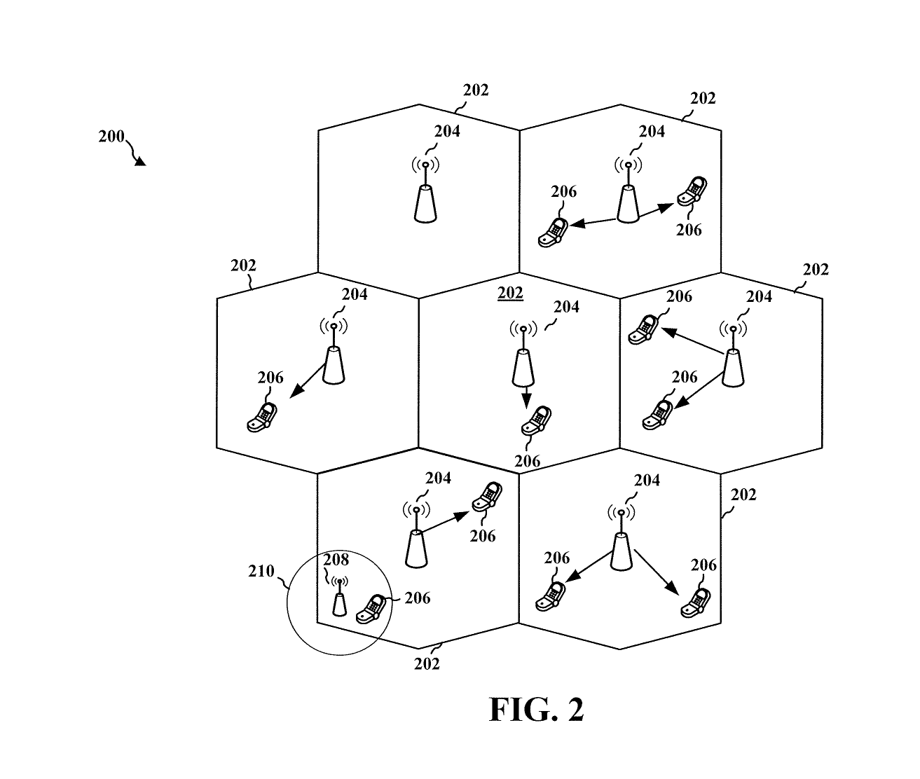

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. An eNB may support one or multiple (e.g., three) cells (also referred to as a sectors). The term “cell” can refer to the smallest coverage area of an eNB and/or an eNB subsystem serving are particular coverage area. Further, the terms “eNB,” “base station,” and “cell” may be used interchangeably herein.

The modulation and multiple access scheme employed by the access network 200 may vary depending on the particular telecommunications standard being deployed. In LTE applications, OFDMA is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

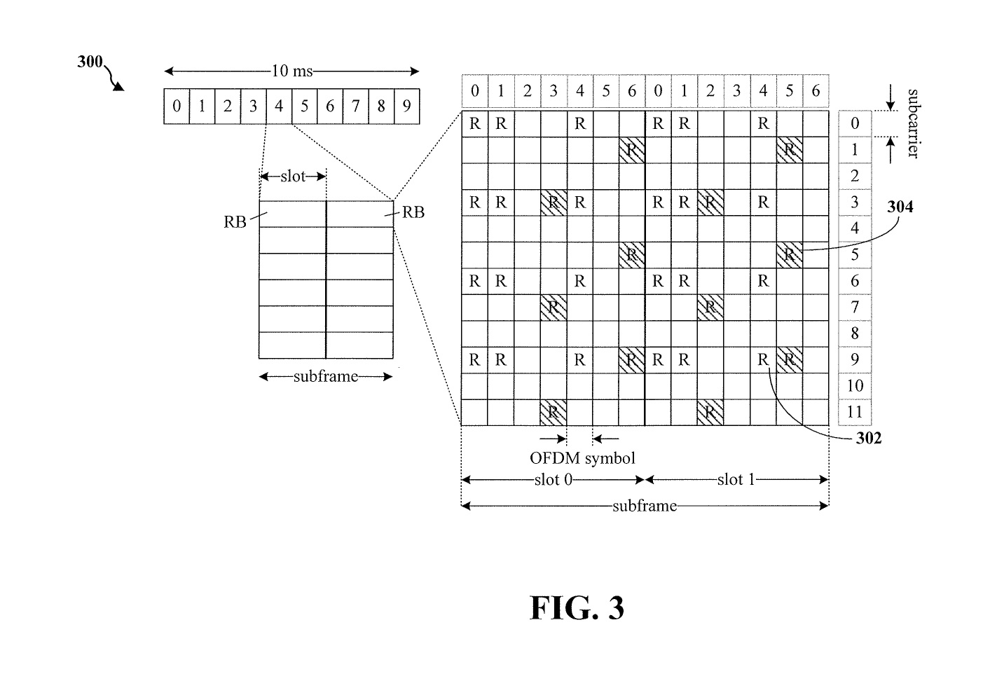

FIG. 3 is a diagram 300 illustrating an example of a DL frame structure in LTE using normal cyclic prefix. A frame (10 ms) may be divided into 10 equally sized subframes each of duration 1 ms. Each subframe may include two consecutive time slots. A resource grid may be used to represent two time slots, each time slot including a resource block. The resource grid is divided into multiple resource elements. In LTE, for a normal cyclic prefix, a resource block contains 12 consecutive subcarriers in the frequency domain and 7 consecutive OFDM symbols in the time domain, for a total of 84 resource elements. For an extended cyclic prefix, a resource block contains 12 consecutive subcarriers in the frequency domain and 6 consecutive OFDM symbols in the time domain, for a total of 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

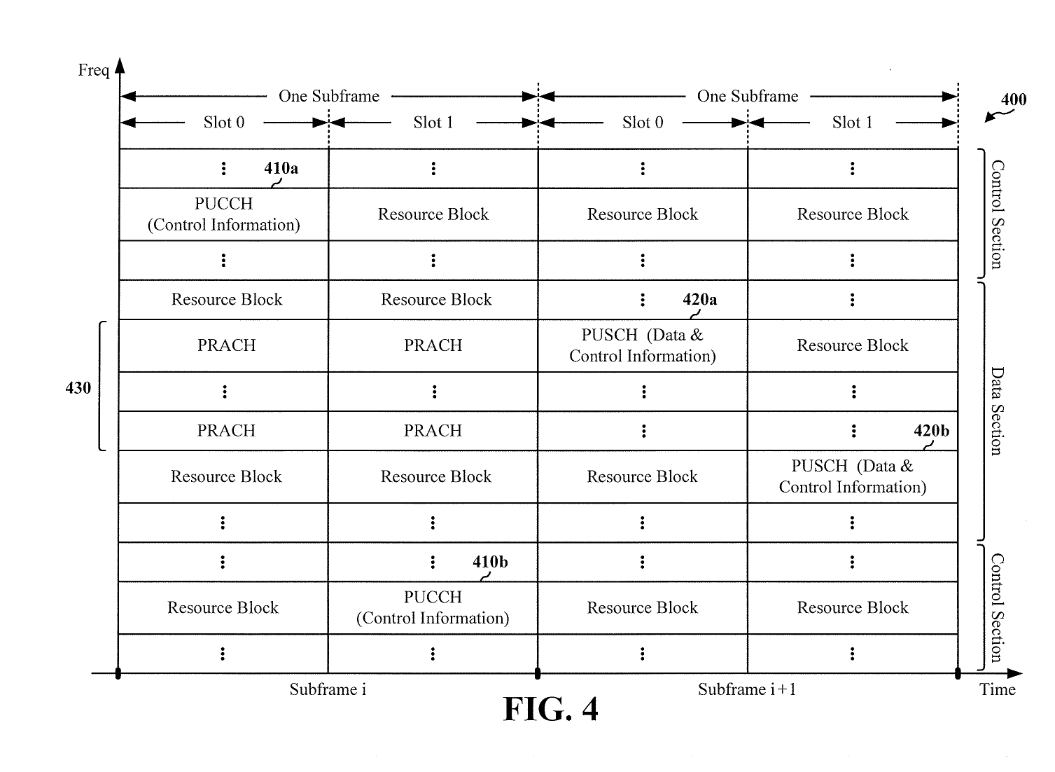

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

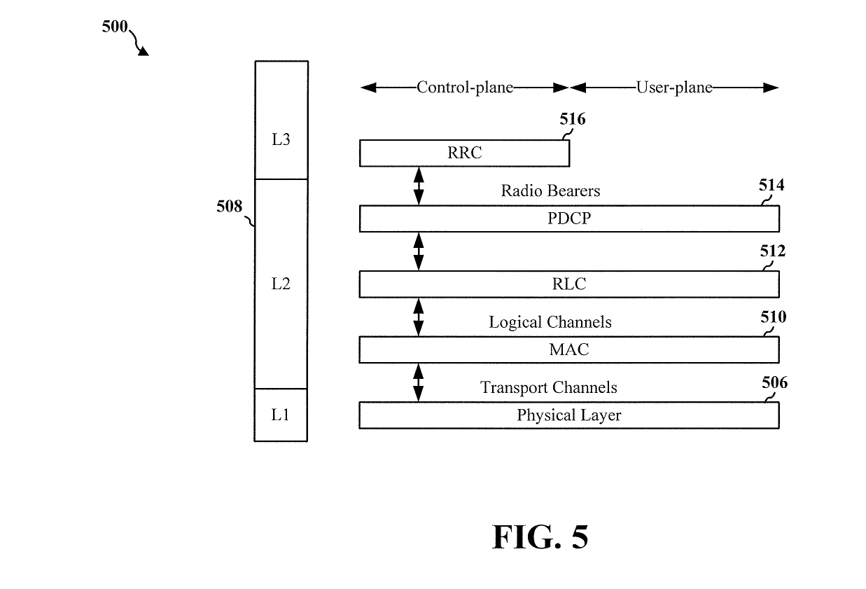

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (e.g., radio bearers) and for configuring the lower layers using RRC signaling between the eNB and the UE.

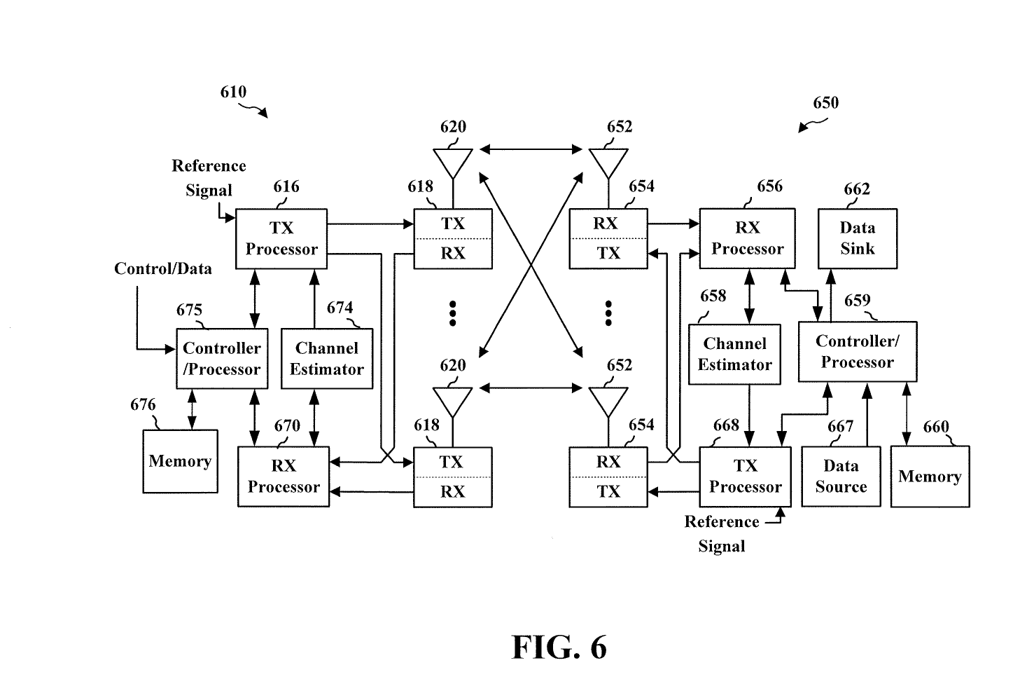

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream may then be provided to a different antenna 620 via a separate transmitter 618TX. Each transmitter 618TX may modulate an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 may perform spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 may be provided to different antenna 652 via separate transmitters 654TX. Each transmitter 654TX may modulate an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations

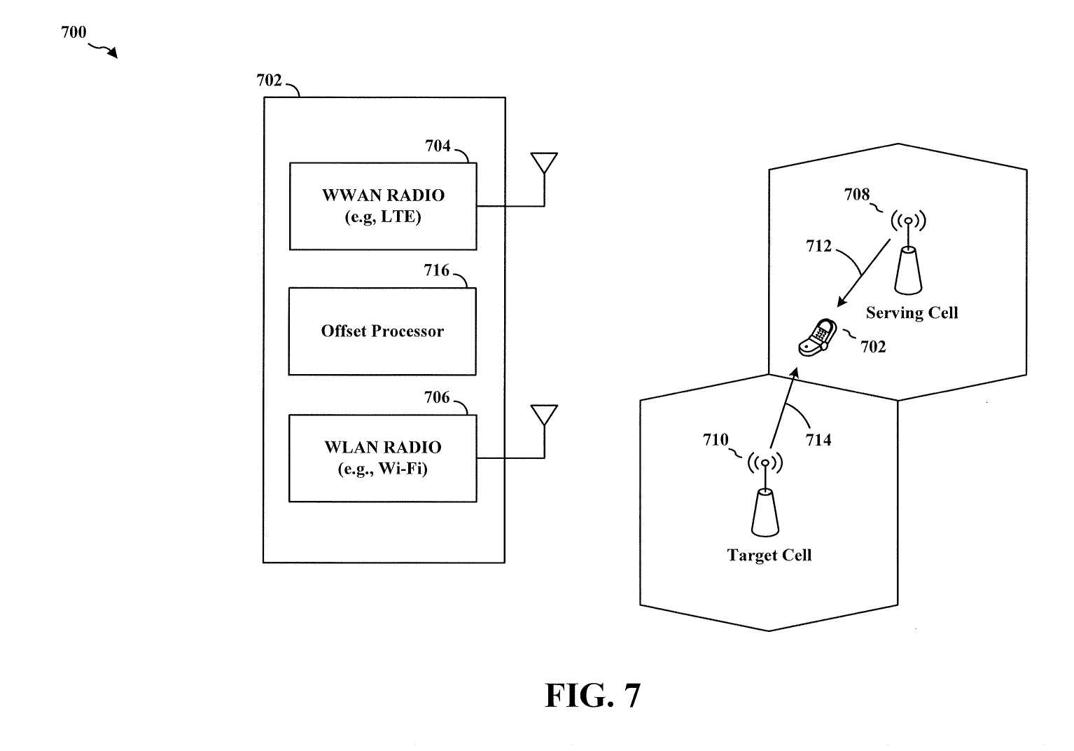

FIG. 7 is an illustration 700 of a UE 702 with multiple radios. The UE 702 may contain a WWAN (2/3/4G LTE) radio 704 and WLAN (802.11) radio 706. Although WWAN radios and WLAN radios are initially designed for specific communication needs, with advances in technology and needs for higher data rates, the use of these two types of radios has started to overlap. It is possible to use a WLAN modem 706 whenever it is available to assist the WWAN modem 704 and vice versa. One such assistance can be during inter-frequency measurements for LTE. For example, when the UE 702 is in connected mode with a serving cell 708, the WLAN radio 706 may assist in cell search and cell measurement for LTE at other frequencies than the serving cell frequency. For example, a UE 702 may need to monitor neighboring cells for potential handovers when the serving cell signal strength becomes weak compared to a predefined threshold. When the neighbor cell is on a frequency different than the current serving frequency, the neighbor cell search and measurement is an inter-frequency cell search and measurement. The carrier frequency of a “target” inter-frequency neighbor cell 710 is referred to as “target frequency.” When the target frequency is sufficiently apart from the serving cell frequency, the measurements on target frequency will require the UE 702 to tune away from its serving frequency. Note that the target frequency may belong to the same frequency band as the serving frequency, or it may belong to a different frequency band.

In a baseline operation of a UE 702 having both a WWAN modem 704 and a

WLAN modem 706, the WLAN radio may be used to measure one or more target cells 710 on one or more target frequencies, while the WWAN modem measures serving cells 708 on the serving frequency. As used herein, a “serving cell” 708 is a cell with which the WWAN modem 704 is currently connected to, i.e. has a radio connection. The serving cell 708 has a base station that communicates with the WWAN modem 704 of the UE 702 over a serving frequency An inter-frequency cell referred to as the “target cell” 710 is the cell where the WWAN modem 704 needs to tune away to do inter-frequency measurements on frequencies different from the serving frequency.

If the UE has one receive chain or the UE has multiple receive chains all of which are configured to operate with the serving cell, assistance from the WLAN radio 706 is beneficial because performance of inter-frequency cell search and measurements by the LTE modem 704 itself requires the UE to tune away from the serving frequency, and thus the serving cell, to other frequencies to obtain measurements. The LTE modem 704 may tune away during specified times referred to as measurement gaps. The inter-frequency measurement gaps are configured by the serving eNB allowing the UE to tune away from serving frequency for inter-frequency cell search and measurements. The UE is not scheduled any DL packets during these measurement gaps and thus is not receiving any data from the serving cell 708. Similarly the UE cannot transmit UL packets during these measurement gaps to the serving cell 708. This results in loss of DL and UL throughput as opposed to the case where the UE is not scheduled any measurement gaps.

The use of the WLAN modem 706 to assist inter-frequency measurements avoids measurement gaps, results in higher throughput and better user experience. The WLAN modem 706 may be in idle mode while the WWAN modem 704 is in connected mode. Thus, the WLAN modem 706 is available for assisting inter-frequency WWAN measurements. Even when the WLAN modem 706 is in connected mode, the WLAN modem 706 can create gaps in WLAN Tx/Rx for the WWAN inter-frequency measurements if needed.

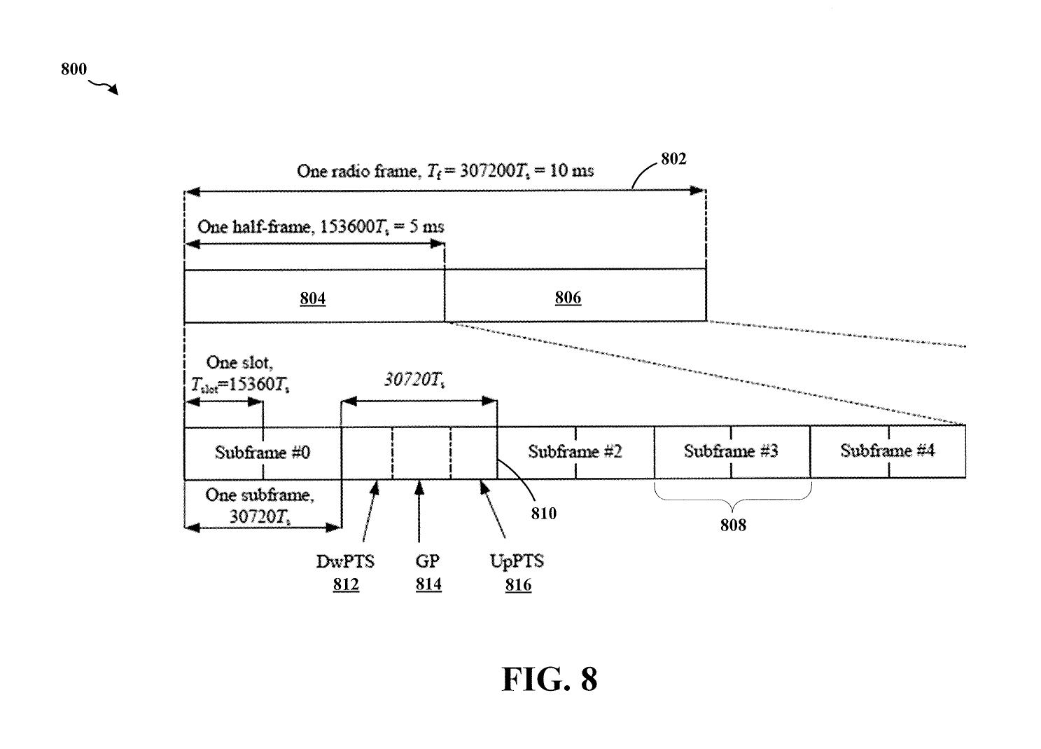

FIG. 8 is an illustration 800 of a radio communication frame structure of TDD-LTE in the time domain. Each radio frame 802 is 10 ms long and includes two 5 ms half-frames 804, 806. Each half-frame 804, 806 includes five 1 ms subframes 808, designated subframe #0 through subframe #4 in the first half-frame, and subframe #5 through subframe #9 in the second half-frame (not shown in FIG. 8). Thus, one radio frame 802 includes ten subframes 808, designated subframe #0 through subframe #9.

In TTD-LTE, subframe #0 and subframe #5 are always downlink subframes, subframe #1 is always a special subframe indicating downlink to uplink switch, and subframe #2 is always an uplink subframe. The rest of the subframes may be uplink or downlink or special subframes depending on the UL/DL configuration. Special subframes, e.g., subframe #1 810, are divided into three regions, including a first region 812 (DwPTS), during which downlink activity occurs, a third region 816 (UpPTS), during which uplink activity occurs, and a second region 814 (GP) which separates the first and third regions.

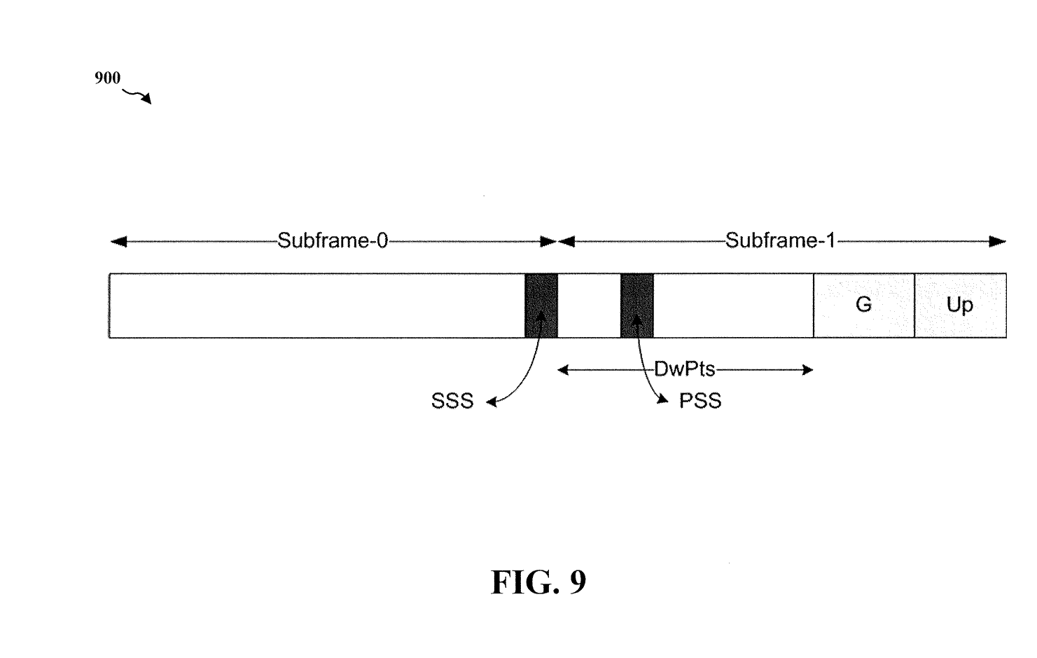

FIG. 9 is an illustration 900 of a subframe #0 and subframe #1 of FIG. 8, showing the locations of PSS and SSS. Cell search, including in particular inter-frequency neighbor cell search in LTE, involves the detection of PSS and SSS. PSS and SSS are transmitted periodically by a communications network, for example, in every radio frame and occur at the same place and at the same time. For example, PSSs have a 5 ms transmission periodicity and thus occur at a point in time in subframe 0 and again at the same point in time 5 ms later in subframe 5 (not shown). PSS occurs at the same times in the next radio frame. SSS signals have two 5 ms phases and therefore have a transmission periodicity of 10 ms. The first phase SSS occurs at a point in time in subframe 0, and again at the same point in time 10 ms later in the next radio frame. The second phase SSS occurs 5 ms after the first phase SSS in subframe 5 (not shown), and again at the same point in time 10 ms later in the next radio frame.

In general, cell search implementation relies on measurement gaps to capture approximately 5.1 ms continuous data samples for PSS/SSS detection. Usually a slightly larger measurement gap (e.g., 6 ms) is needed in order for the modem to tune away to a next frequency, and then to tune back to the original frequency, after capturing signals. The measurement gaps may occur with a specific periodicity (e.g., every 40 ms or 80 ms) depending on the measurement gap pattern. Accordingly, such detection typically requires a modem that is able to collect signal samples at once across a 5.1 ms duration of a radio frame.

A WWAN modem is able to collect the required number of consecutive samples at once. A WLAN modem, however, may or may not be able to collect the required number of consecutive samples at once. For example, due to buffer limitations and the need for explicit triggering, a WLAN modem may not be able to collect a 5.1 ms duration of samples in one shot. In cases where a WLAN modem is not available or able to collect a 5.1 ms duration of data samples at once, the WLAN modem may still assist in cell search by capturing data samples over multiple capture periods.

In FDD-LTE, the WLAN receive chain of a WLAN modem that is used to capture signals of interest typically has a low noise amplifier (LNA) gain state that is at a constant value throughout sample capture. In TDD-LTE, however, since downlink and uplink subframes are time multiplexed across the same shared spectrum, the received signal may have significant variation across a 5.1 ms sample capture. In order to capture the downlink samples with proper LNA gain setting, an automatic gain control (AGC) algorithm requires setting the LNA gain state once every 0.5 ms. With reference to FIG. 9, in TDD-LTE each subframe has 14 ODFM symbols for normal cyclic prefix. PSS and SSS are one OFDM symbol each. For cell search, PSS and SSS should be captured with the correct LNA gain state. If the LNA gain state is too low, then PSS and SSS may be lost because of noise and/or interference. On the other hand, if the LNA gain state is too high, the sample captures may saturate, thus resulting in undetectable PSS and SSS.

Setting of the LNA gain state may involve changing the current LNA gain state to a different gain state based on calculations performed by an AGC algorithm, or retaining the current LNA gain state in cases where the gain state calculated by the AGC algorithm happens to be the same as the current gain state. A change in LNA gain state occur at the periodic time boundaries. LNA gain state remains fixed for the rest of the time. A typical value for the periodicity is 0.5 ms.

With continued reference to FIG. 9, because the SSS is always in the last OFDM symbol of subframe #0 and subframe #0 is always a downlink subframe, it is guaranteed that at least the thirteen OFDM symbols prior to the OFDM symbol that carries the SSS are downlink symbols. Therefore, an LNA gain state calculated from the energy measurement of a window of 0.5 ms is guaranteed to be measured on the downlink if the 0.5 ms window following the measurement window includes SSS. Furthermore, if the 0.5 ms measurement window happens to occur before the OFDM symbol that carries the PSS, then the LNA gain setting is also guaranteed to be measured in the downlink because the time leading up to the PSS falls within the downlink region of subframe #1. Accordingly, if energy is measured at each 0.5 ms window and an LNA gain state is derived for that 0.5 ms window and applied to the next 0.5 ms window, then the LNA gain state will be correct for the PSS and SSS. This process of deriving and setting LNA gain states is referred to as a pipeline operation.

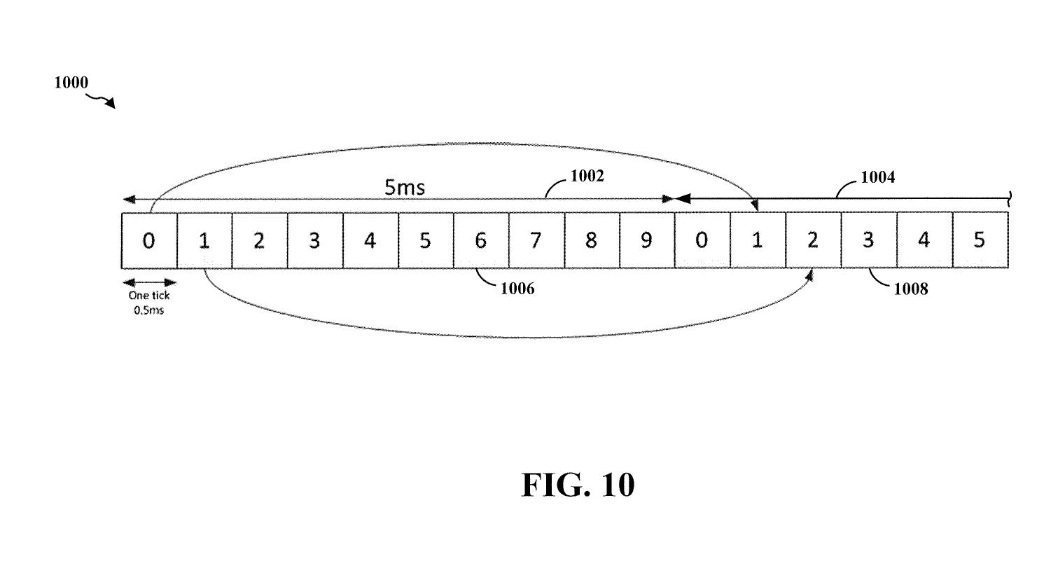

FIG. 10 is an illustration 1000 of a pipeline operation for deriving and setting LNA gains states. The pipeline includes a 5 ms measurement period 1002 followed by a 5 ms capture period 1004. The measurement period 1002 is divided into a number (n) of contiguous measurement durations 1006. In this example, the 5 ms period is divided into ten 0.5 ms durations. The capture period 1004 is divided into a number (n) of contiguous capture durations 1008. In this example, the 5 ms period is divided into ten 0.5 ms durations. These durations 1006, 1008 are referred to as “ticks” and, in the case of the measurement period 1002 correspond to measurement windows during which energy measurements are obtained for deriving LNA gain states. In the case of the capture period 1004, the ticks correspond to capture durations during which data samples are captured. Neither the measurement ticks 1006 nor the capture ticks 1008 may necessarily align with LTE subframes or slots illustrated in FIGS. 8 and 9. The duration of the measurement period 1002 and the capture period 1004 may be a function of the signals of interest to be captured. For example, the measurement period 1002 and capture period 1004 in FIG. 10 is 5 ms because of the 5 ms periodicity of PSS transmissions and the 10 ms periodicity of SSS phase 1 and phase 2 transmissions.

In the pipeline operation, energy is measured within each measurement tick 1006 and an LNA gain state is derived based on the measure. The derived LNA state calculated at tick n is applied at tick n+1 in the next 5 ms capture period 1004. For example, at tick #0, an LNA gain state is derived using techniques known in the art, based on energy measurements obtained during that tick, and the derived LNA gain state is applied to tick #1, in the next 5 ms capture period 1004. The delay in applying the derived LNA gain state to a subsequent tick is necessary as applying it to an immediate next tick may not be possible because of the delay in processing and deriving the LNA gain state. If the LNA gain state can be changed every 0.5 ms on the WLAN ADC capture path hardware, then the conventional pipeline algorithm described above can be applied as is. However, changing the LNA gain state every 0.5 ms may put extra burden on the hardware.

Disclosed herein are techniques for capturing a signal of interest periodically transmitted by a WWAN using a WLAN receive chain, that reduce the aforementioned burdens. Some techniques take advantage of the fact that the signals of interest, e.g., PSS and SSS, have a periodicity of transmission and are, for example, transmitted every 5 ms. In these techniques, data samples are captured over multiple capture periods and concatenated to form continuous data samples of length 5 ms. In other techniques, a single LNA gain state is selected that allows for 5 ms of data samples captures during a single capture period.

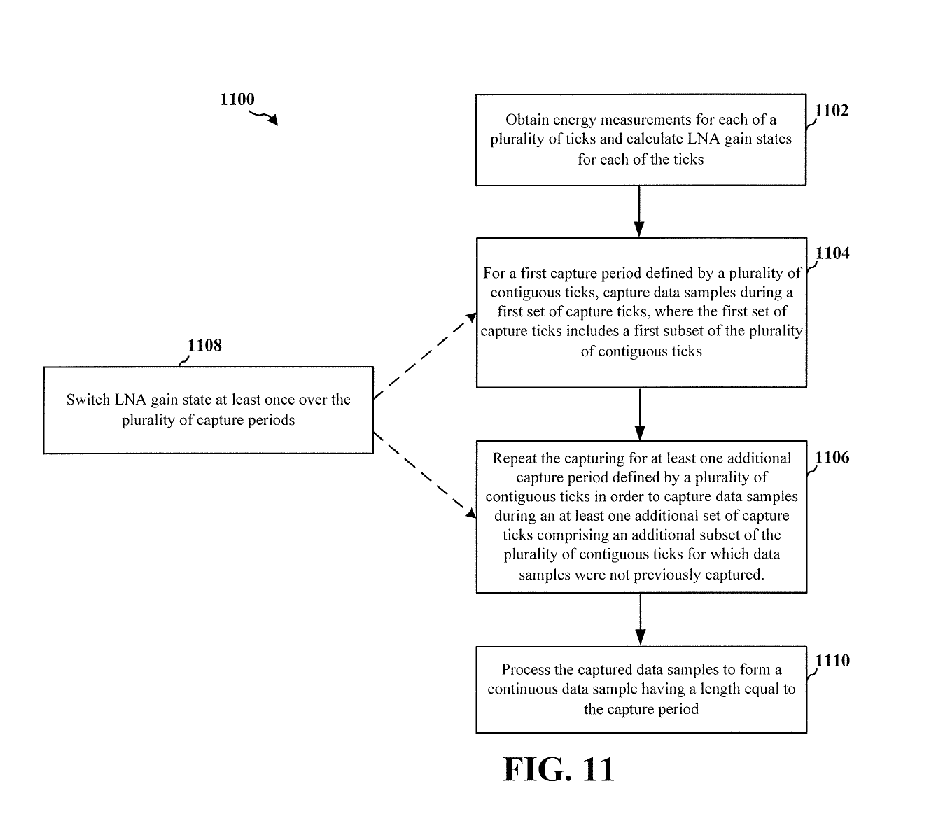

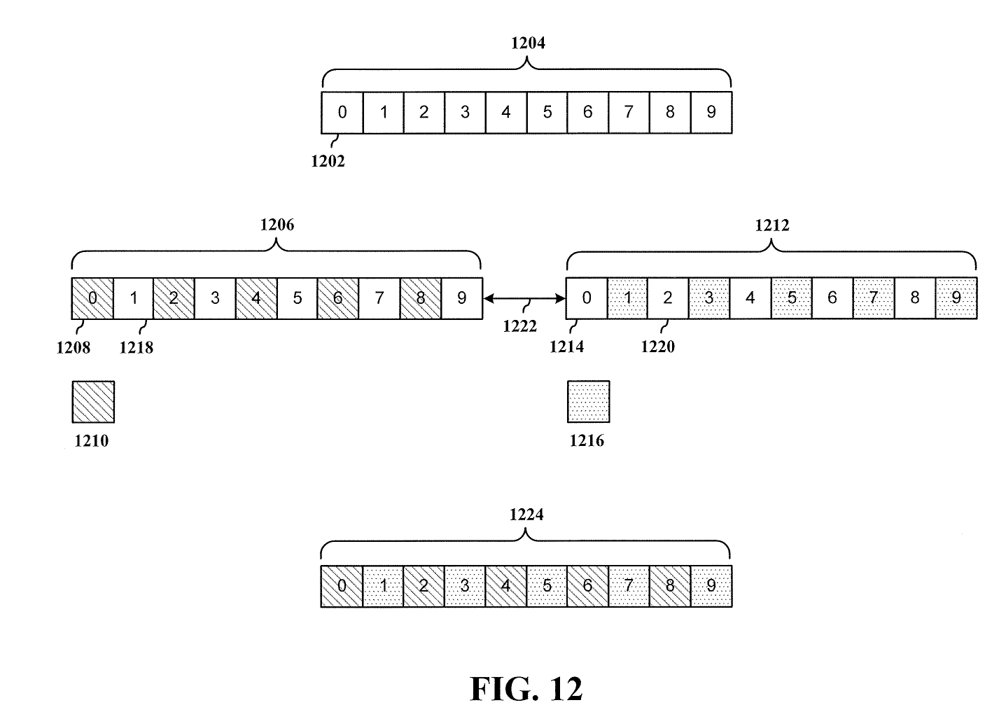

FIG. 11 is a flow chart 1100 of a method of capturing a plurality of data samples over multiple capture periods to form continuous data including a signal of interest periodically transmitted by a WWAN. The method may be performed by a UE. FIG. 12 is an example depiction of the method of FIG. 11, and includes multiple capture periods 1202, 1208, each defined by a respective plurality of contiguous ticks 1204, 1210; and continuous data 1220 formed by data samples captured during sets of capture ticks 1206, 1212.

Returning to FIG. 11, at step 1102, the UE obtains energy measurements for each of a plurality of ticks and calculates LNA gain states for each of the ticks. An energy measurement is obtained for each measurement tick 1202 within a measurement period 1204. For example, in the case of a 5 ms measurement period 1204, ten energy measurements may be obtained, each measurement corresponding to a measurement for a 0.5 ms measurement tick 1202. The actual duration for the energy measurement can be less than 0.5 ms. In other word, while the measurement tick 1202 may be 0.5 ms in duration, the energy measurement for that tick may be based on a portion of the tick less than 0.5 ms. The process of measuring tick energy and calculating LNA gain states is known in the art and, accordingly, is not described herein.

At step 1104, for a first capture period 1206 defined by a plurality of contiguous ticks 1208, the UE captures data samples during a first set of capture ticks 1210. The first set of capture ticks 1210 includes a first subset of the plurality of contiguous ticks 1208. The capturing is done using a WLAN receive chain having a switchable LNA gain state.

At step 1106, the UE repeats the capturing for at least one additional capture period 1212 defined by a plurality of contiguous ticks 1214 in order to capture data samples during an at least one additional set of capture ticks 1216 comprising an additional subset of the plurality of contiguous ticks 1214 for which data samples were not previously captured.

At step 1108, the UE switches the LNA gain state at least once over the plurality of capture periods 1206, 1212. For example, the LNA gain state may be switched during one or more no capture ticks 1218, 1220 of one or more of the capture periods 1206, 1212. Alternatively, the LNA gain state may be switched during a delay time 1222 between the capture periods.

At step 1110, the UE processes the captured data samples to form continuous data 1224 by combining the data samples captured during the two capture period 1206, 1212. For example, the data samples may be concatenated.

As mentioned above, in one configuration, the LNA gain state may be switched during one or more no capture ticks 1218, 1220 of the capture period 1206, 1212. For this configuration, each of the capture ticks 1210, 1216, has an associated LNA gain state, as determined, for example at step 1002. The LNA gain state of the WLAN receive chain is switched during a no capture period 1218, 1220 to correspond to the LNA gain state of the next capture tick 1210, 1216 in the set of capture ticks.

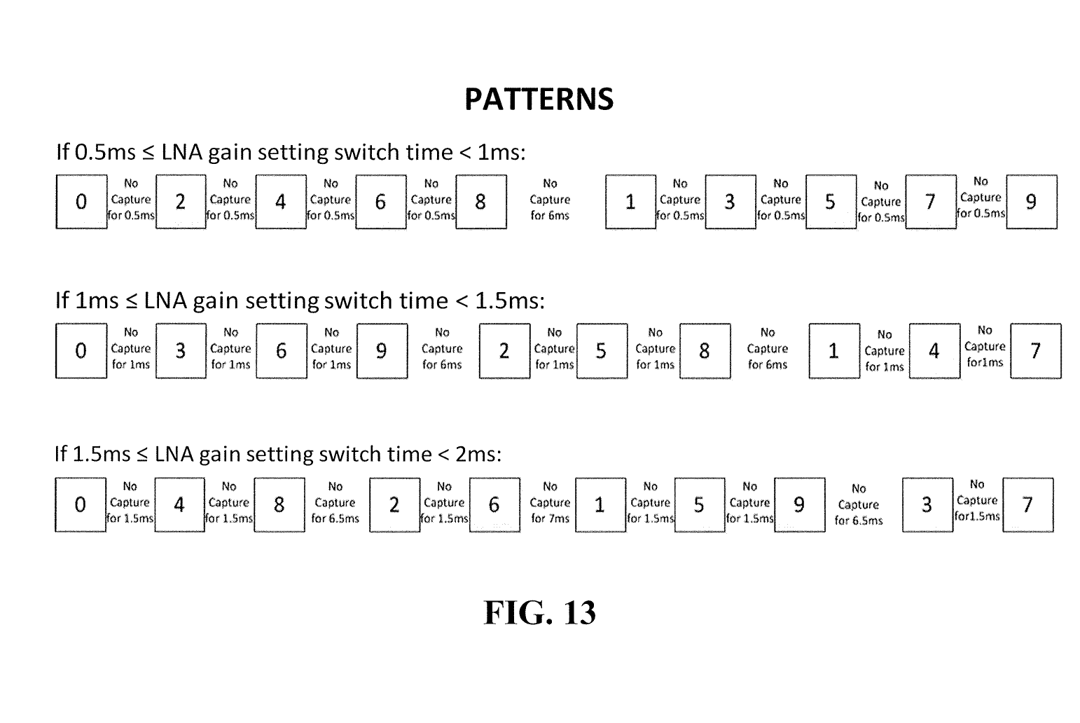

With reference to FIG. 13, sets of capture ticks may be characterized by a pattern of ticks, including for example, every other tick within the plurality of contiguous ticks, every third tick within the plurality of contiguous ticks, and every fourth tick within the plurality of contiguous ticks. The pattern may be a function of the switch time of the LNA gain state. For example, if the LNA gain state switch time is between 0.5 ms and 1 ms, then for a first capture period, the derived LNA gain state for tick #0 may be applied to the LNA and samples may be captured for a period of time corresponding to capture tick #0. This capture tick is followed by no capture tick. During this no capture tick, the LNA gain state is switched to the LNA gain state derived for capture tick #2. Samples may then be captured for a period of time corresponding to capture tick #2. This capture tick is followed by a no capture tick. This process is repeated until the 5 ms time period has elapsed.

During this 5 ms capture period, data samples are captured during the even ticks. In order to capture data sufficient to form continuous data of 5 ms, the capture—no capture cycle is repeated during a second 5 ms capture period. During this capture period, data samples are captured during the odd ticks. A delay time, during which there is no capture, occurs between the two 5 ms capture periods. This delay time is of a duration sufficient to allow for capture of a signal of interest having a transmission periodicity greater than 5 ms. For example, in the case of SSS, there is a phase 1 SSS and a phase 2 SSS. Each respective SSS phase signal is transmitted every 10 ms. Accordingly, in order to ensure capture of one of the SSS phase signals, the delay time between the two 5 ms capture periods is 6 ms. During this delay time, the SSS phase not transmitted during the first 5 ms period of time is transmitted.

Upon completing the second cycle of captures, the individual samples captured are put in tick number order to form a continuous array of data samples. The continuous array has a duration of 5 ms and includes one or more signals of interest, such as a PSS and one of the SSS phases. In order to capture the other SSS phase, the process may be repeated upon completion of the second 5 ms capture with only a 0.5 ms delay time between the last capture period and the next capture period.

In another example, if the LNA gain state switch time is between 1.0 ms and 1.5 ms, then the derived LNA gain state for tick #0 may be applied to the LNA and data samples may be captured for a period of time corresponding to capture tick #0. This capture tick is followed by a no capture tick. During this no capture tick, the LNA gain state is switched to the LNA gain state derived for tick #3. Data samples may then be captured for a period of time corresponding to capture tick #3. This capture tick is then followed by a no capture tick. This process is repeated until the 5 ms capture period has elapsed.

During this 5 ms capture period samples are captured for every third tick, i.e., ticks #0, 3, 6, and 9. In order to capture data sufficient to form continuous data samples of 5 ms, the capture—no capture cycle is repeated for two more 5 ms capture periods. During the first of these additional capture periods, data samples are captured during ticks #2, 5 and 8. During the second of the additional capture periods, data samples are captured during ticks # 1, 4 and 7. As with the first example, a time delay sufficient to allow for capture of a signal of interest having a transmission periodicity greater than 5 ms occurs between the 5 ms capture periods.

Upon completing the second and third cycle of data sample captures, the individual samples are put in tick number order to form a continuous array of data samples. The continuous array has a duration of 5 ms and includes one or more signals of interest, such as a PSS and one of the SSS phases.

In another example, if the LNA gain state switch time is between 1.5 ms and 2.0 ms, then the derived LNA gain state for tick #0 may be applied to the LNA and samples may be captured for a period of time corresponding to capture tick #0. This capture tick is followed by a no capture tick. During this no capture tick, the LNA gain state is switched to the LNA gain state derived for tick #4. Data samples may then be captured for a period of time corresponding to capture tick #4. This capture tick is then followed by a no capture tick. This process is repeated until the 5 ms capture period has elapsed.

During this 5 ms capture period data samples are captured for every fourth tick, i.e., ticks #0, 4, and 8. In order to capture data sufficient to form continuous data of 5 ms, the capture—no capture cycle is repeated for three more 5 ms capture periods. During the first of these additional capture periods, data samples are captured during ticks #2 and 6. During the second of the additional capture periods, data samples are captured during ticks # 1, 5 and 9. During the third additional capture periods, data samples are captured during ticks # 3 and 7. As with the first example, a delay time sufficient to allow for capture of a signal of interest having a transmission periodicity greater than 5 ms occurs between the 5 ms capture periods.

Upon completing the second, third and fourth cycles of captures, the individual data samples are put in tick number order to form a continuous array of data samples. The continuous array has a duration of 5 ms and includes one or more signals of interest, such as a PSS and one of the SSS phases.

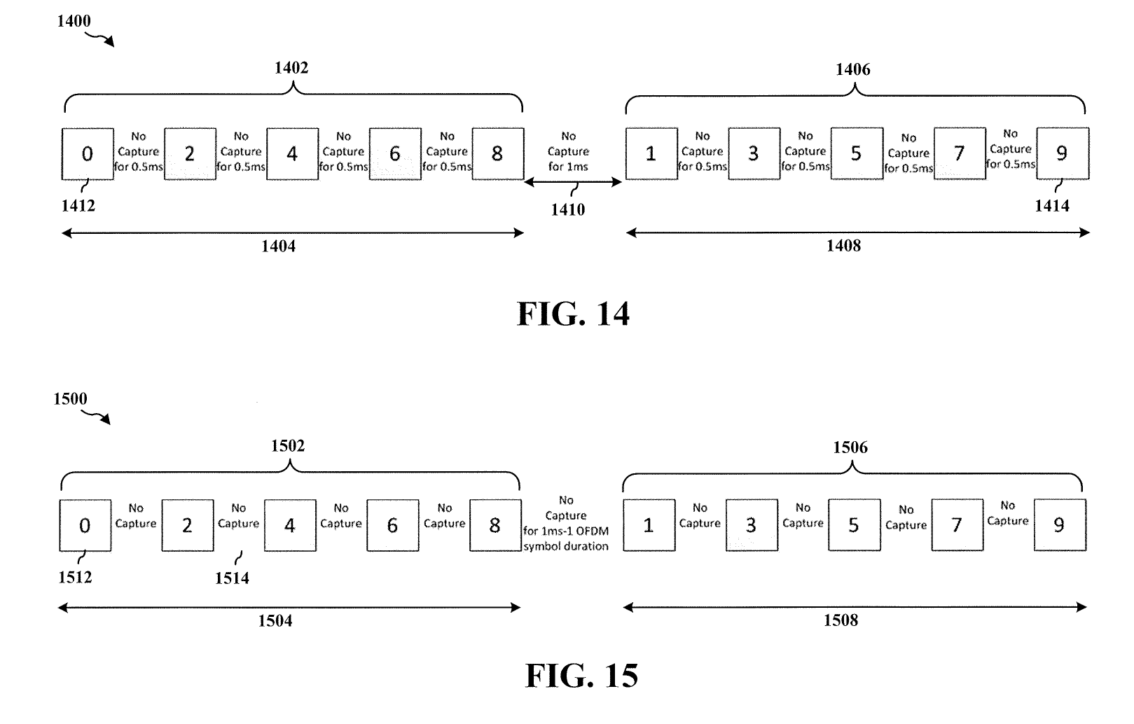

FIG. 14 is an illustration 1400 of capture sets 1402, 1406 for capturing a signal of interest having a periodicity of 5 ms. The first set of capture ticks 1402 is captured during a first capture period 1404, and the second set of capture ticks 1406 is captured during a second capture period 1408. In some cases, the process of FIG. 13 may be expedited by reducing the delay time 1410 between the 5 ms capture periods 1402, 1406. For example, in the case of PSS, which has a periodicity of 5 ms, the delay time 1410 may be reduced from 6 ms to 1 ms.

Upon completion of the second capture set 1406, the ten data sample captured during the ten capture ticks 1412 are concatenated to form a continuous sample capture of 5 ms duration. PSS detection is then performed on the 5 ms duration. During this detection, if the UE determines that SSS is wholly captured within any of the ten data samples captured during the ten capture ticks 1412, then SSS detection may be performed using the same continuous sample capture of 5 ms duration used for PSS detection. If SSS is not wholly captured in any of the ten captured data samples then additional data samples are captured during a next capture period. The start of the next capture period may be separated from the last tick 1414 of the second capture set 1406 by a delay time of 0.5 ms. Data samples captured during this next capture period are concatenated with the data samples captured during the first capture period 1404, to form a continuous sample capture of 5 ms and SSS detection is performed on the 5 ms of data.

FIG. 15 is an illustration 1500 of sets of capture ticks 1502, 1506 for capturing a signal of interest that is only partially captured. The first set of capture ticks 1502 is captured during a first capture period 1504, and the second set of capture ticks 1506 is captured during a second capture period 1508. In some cases, either PSS or SSS may be partially captured in any of the data samples captured during the ten capture ticks 1512. In this case, the duration of the capture ticks 1512 may be increased to 0.5 ms+1 OFDM symbol, while the duration of the no capture ticks 1514 may be decreased to 0.5 ms minus 1 OFDM symbol duration. In TDD, PSS and SSS are separated by 3 OFDM symbols, as such; adjusting the durations of the capture ticks 1512 and the no capture ticks 1514 as described ensures that neither PSS nor SSS is partially captured in any of the ten capture ticks 1512. In this configuration, the captured data samples are not combined. Instead, the data samples are fed directly to the PSS and SSS detection engines.

In some cases, the number of LNA gain states may be limited. For example, there may be three or four different states. Accordingly, in another configuration, data samples may be captured during a number of capture periods with the LNA gain state remaining fixed during each respective capture period, while being changed between capture periods.

For example, with reference to FIG. 12, the LNA gain state of the WLAN receive chain may be set to a first LNA gain state for the first capture period 1206. The first LNA gain state may correspond to one of a plurality of LNA gain states previously derived for the plurality of contiguous ticks 1208. Prior to capturing data samples during the second capture period 1212, and during the delay time 1222 between the first capture period 1206 and the second capture period 1212, the LNA gain state of the WLAN receive chain is switched to another LNA gain state corresponding to one of the plurality of LNA gain states.

The plurality of LNA gain states is derived by determining the LNA gain state for each tick in a capture period 1204. For example, in the case of a 5 ms capture period having ten 0.5 ms measurement ticks 1202, energy is measured for each tick. The duration for the energy measurement can be less than the duration of the tick 1202. This gives ten energy measurement results. Based on these measurement results, a LNA gain state is derived for each tick using techniques known in the art. In some cases, some ticks may have the same LNA gain state. Accordingly, the number of LNA gain states may be less than the number of ticks.

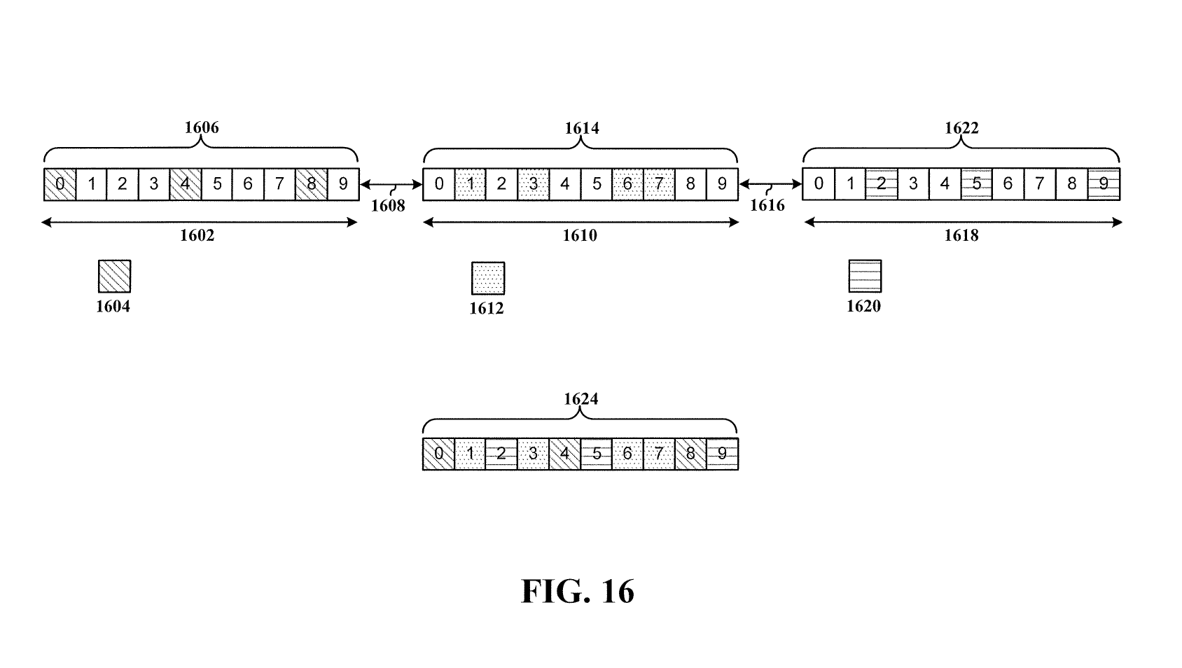

With reference to FIG. 16, assuming there are only three different LNA gain states resulting, the process proceeds as follows: The LNA gain state is set to a first of the three states for a first capture period 1602. Data samples are captured for those ticks 1604 within the first capture period 1602 that have an LNA gain state that corresponds to the first LNA gain state. The captured data samples captured during the first capture period 1602 form a first set of captured data samples 1606.

During a delay time 1608, the LNA gain state is set to a second of the three states for a second capture period 1610. Data samples are captured for those ticks 1612 within the second capture period 1610 that have an LNA gain state that corresponds to the second LNA gain state. The captured data samples captured during the second capture period 1610 form a second set of captured data samples 1614.

During a delay time 1616, the LNA gain state is set to a third of the three states for a third capture period 1618. Data samples are captured for those ticks 1620 within the third capture period 1618 that have an LNA gain state that corresponds to the second LNA gain state. The captured data samples captured during the third capture period 1618 form a third set of captured data samples 1622.

Upon completion of the third capture period 1618, the UE will have obtained three capture sets 1606, 1614, 1622, the combination of which includes a data sample for each capture tick. The ten data samples captured over the three capture periods 1602, 1608, 1612 are then combined to form continuous data 1624.

In this configuration, the patterns of tick captures are not unique. In other words, the every second, every third, every fourth patterns previously described with reference to FIG. 13 are not applicable. The duration of the capture ticks 1604, 1612, 1620 may be increased or decreased. Doing so, however, affects the number of ticks within a capture period, and thus the number LNA gain states to calculate. Also, in this configuration, if more than one WLAN receive chain is available, the data captures may be interlaced, with a first capture set being done by one WLAN receive chain, and the other capture set may be done by another WLAN receive chain.

The UE may determine to use either one of the above configurations based on the energy measurements and number of LNA gain states. For example, if a small number of LNA gain states are derived, such as described above with reference to FIG. 16, then the UE may decide to implement the technique of FIG. 16, wherein LNA gain states are changed only three times, as opposed to the technique described above with reference to FIG. 13, wherein LNA gain states are switched several times during each capture period.

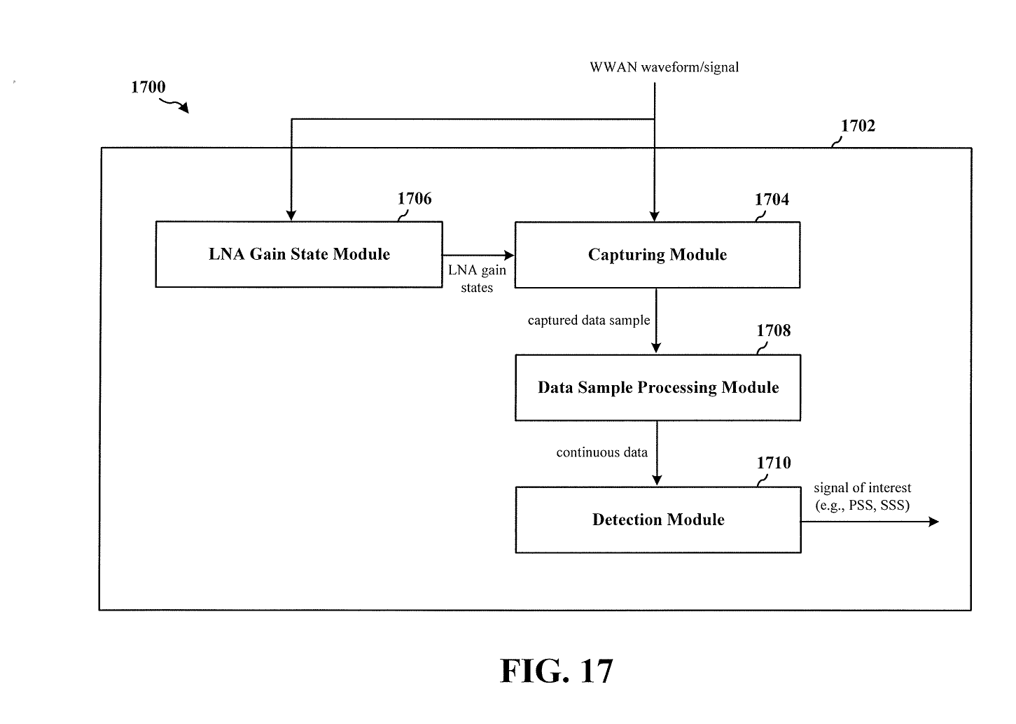

FIG. 17 is a conceptual data flow diagram 1700 illustrating the data flow between different modules/means/components in an exemplary apparatus 1702 that capture a plurality of data samples over a plurality of capture periods to form continuous data including a signal of interest periodically transmitted by a WWAN. The apparatus 1702 may be a UE. The apparatus 1702 includes a capturing module 1704, a LNA gain state module 1706, a data sample processing module 1708, and a detection module 1710.

The capturing module 1704 captures data samples during a first set of capture ticks within a first capture period defined by a plurality of contiguous ticks. The first set of capture ticks includes a first subset of the plurality of contiguous ticks, and the capturing is done using a WLAN receive chain having a switchable LNA gain state. The capturing module 1704 repeats the capturing for at least one additional capture period defined by a plurality of contiguous ticks in order to capture data samples during an at least one additional set of capture ticks comprising an additional subset of the plurality of contiguous ticks for which data samples were not previously captured. During the capturing, the capturing module switches the LNA gain state of the WLAN receive chain at least once over the plurality of capture periods.

The LNA gain state module 1706 determines the LNA gain state for each of the plurality of contiguous ticks within the capture periods. The capturing module 1704 uses these LNA gains states during the capturing process. The data sample processing module 1708 processes the captured data samples to form the continuous data, and the detection module 1710 process the continuous data to detect the signal of interest, e.g., PSS and SSS.

The apparatus may include additional modules that perform each of the steps of the algorithm in the aforementioned flow chart of FIG. 11 and diagrams of FIGS. 12-16. As such, each step in the aforementioned flow chart of FIG. 11 and the diagrams of FIGS. 12-16 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

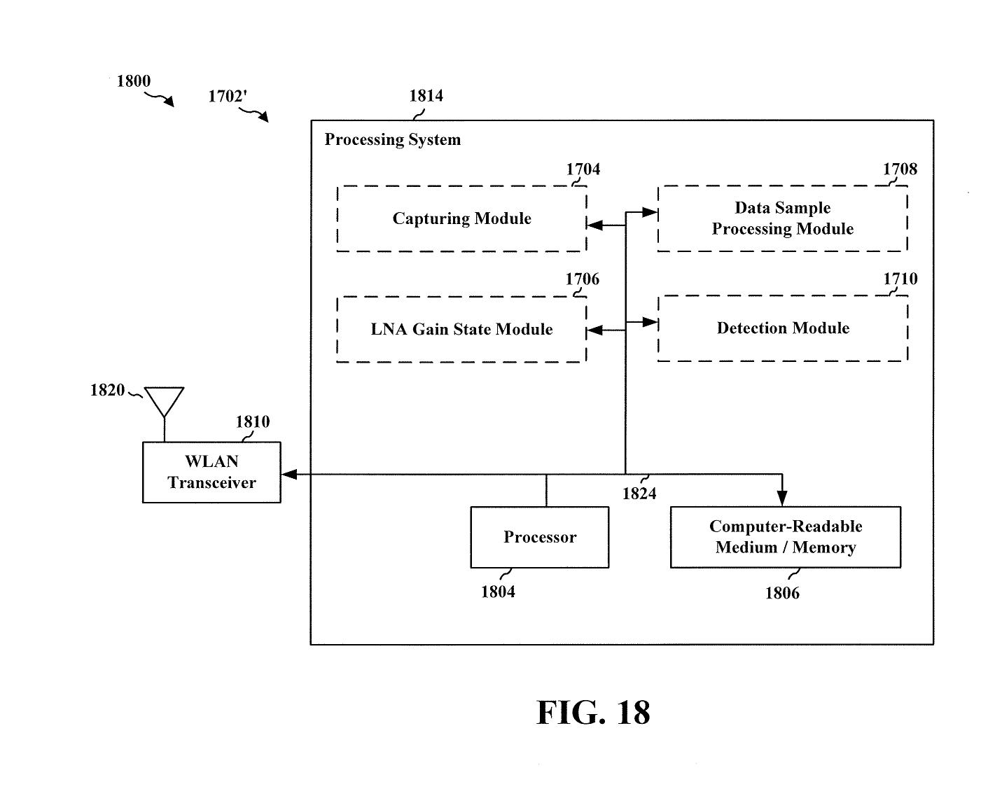

FIG. 18 is a diagram 1800 illustrating an example of a hardware implementation for an apparatus 1802′ employing a processing system 1814. The processing system 1814 may be implemented with a bus architecture, represented generally by the bus 1824. The bus 1824 may include any number of interconnecting buses and bridges depending on the specific application of the processing system 1814 and the overall design constraints. The bus 1824 links together various circuits including one or more processors and/or hardware modules, represented by the processor 1804, the modules 1704, 1706, 1708, 1710 and the computer-readable medium/memory 1806. The bus 1824 may also link various other circuits such as timing sources, peripherals, voltage regulators, and power management circuits, which are well known in the art, and therefore, will not be described any further.

The processing system 1814 may be coupled to a WLAN transceiver 1810. The transceiver 1810 is coupled to one or more antennas 1820. The transceiver 1810 provides a means for communicating with various other apparatus over a transmission medium. The transceiver 1810 receives a signal from the one or more antennas 1820, extracts information from the received signal, and provides the extracted information to the processing system 1814. In addition, the transceiver 1810 receives information from the processing system 1814, and based on the received information, generates a signal to be applied to the one or more antennas 1820.

The processing system 1814 includes a processor 1804 coupled to a computer-readable medium/memory 1806. The processor 1804 is responsible for general processing, including the execution of software stored on the computer-readable medium/memory 1806. The software, when executed by the processor 1804, causes the processing system 1814 to perform the various functions described supra for any particular apparatus. The computer-readable medium/memory 1806 may also be used for storing data that is manipulated by the processor 1804 when executing software. The processing system further includes at least one of the modules 1704, 1706, 1708 and 1710. The modules may be software modules running in the processor 1804, resident/stored in the computer readable medium/memory 1806, one or more hardware modules coupled to the processor 1804, or some combination thereof. The processing system 1818 may be a component of the UE 650 and may include the memory 660 and/or at least one of the TX processor 668, the RX processor 656, and the controller/processor 659.

In one configuration, the apparatus 1702/1702′ for wireless communication includes means for capturing data samples during a first set of capture ticks within a first capture period defined by a plurality of contiguous ticks. The first set of capture ticks includes a first subset of the plurality of contiguous ticks, and the capturing is done using a WLAN receive chain having a switchable LNA gain state. The apparatus 1702/1702′ may also include means for repeating the capturing for at least one additional capture period defined by a plurality of contiguous ticks in order to capture data samples during an at least one additional set of capture ticks comprising an additional subset of the plurality of contiguous ticks for which data samples were not previously captured. During the capturing, the capturing module switches the LNA gain state of the WLAN receive chain at least once over the plurality of capture periods. The apparatus 1702/1702′ may further include means for determining the LNA gain state for each of the plurality of contiguous ticks within the capture periods, means for processing the captured data samples to form the continuous data, and means for processing the continuous data to detect the signal of interest, e.g., PSS and SSS.

The aforementioned means may be one or more of the aforementioned modules of the apparatus 1702 and/or the processing system 1718 of the apparatus 1702′ configured to perform the functions recited by the aforementioned means. As described supra, the processing system 1814 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

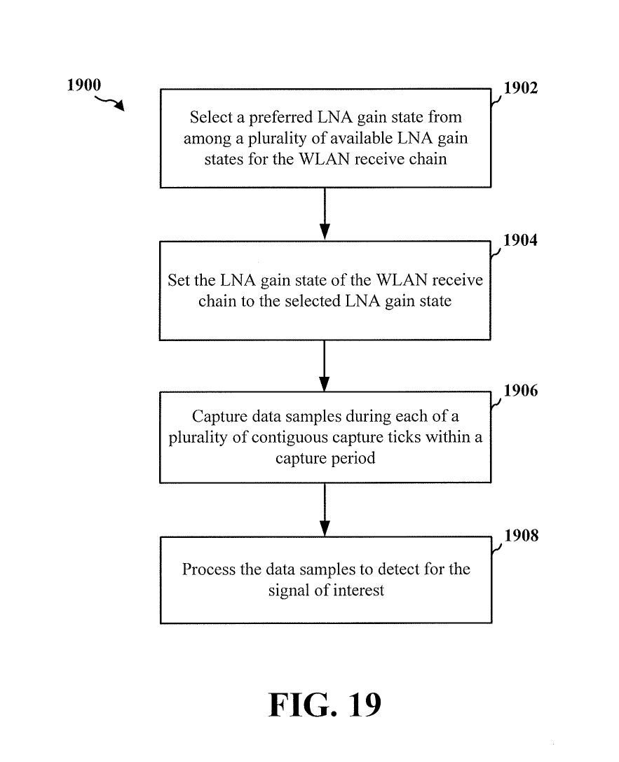

FIG. 19 is a flow chart 1900 of a method of capturing a plurality of data samples during a single capture period using a WLAN receive chain, wherein the data samples include a signal of interest periodically transmitted by a WWAN. The method may be performed by a UE.

At step 1902, the UE selects a preferred LNA gain state from among a plurality of available LNA gain states for the WLAN receive chain. In some configurations, the plurality of available gain states may be limited to a discrete set of LNA gain states. In other configurations, the plurality of available LNA gain states may be derived based on energy measurements.

At step 1904, the UE sets the LNA gain state of the WLAN receive chain to the selected LNA gain state. At step 1906, the UE captures data samples during each of a plurality of contiguous capture ticks within a capture period. At step 1908, the UE processes the data samples to detect for the signal of interest.

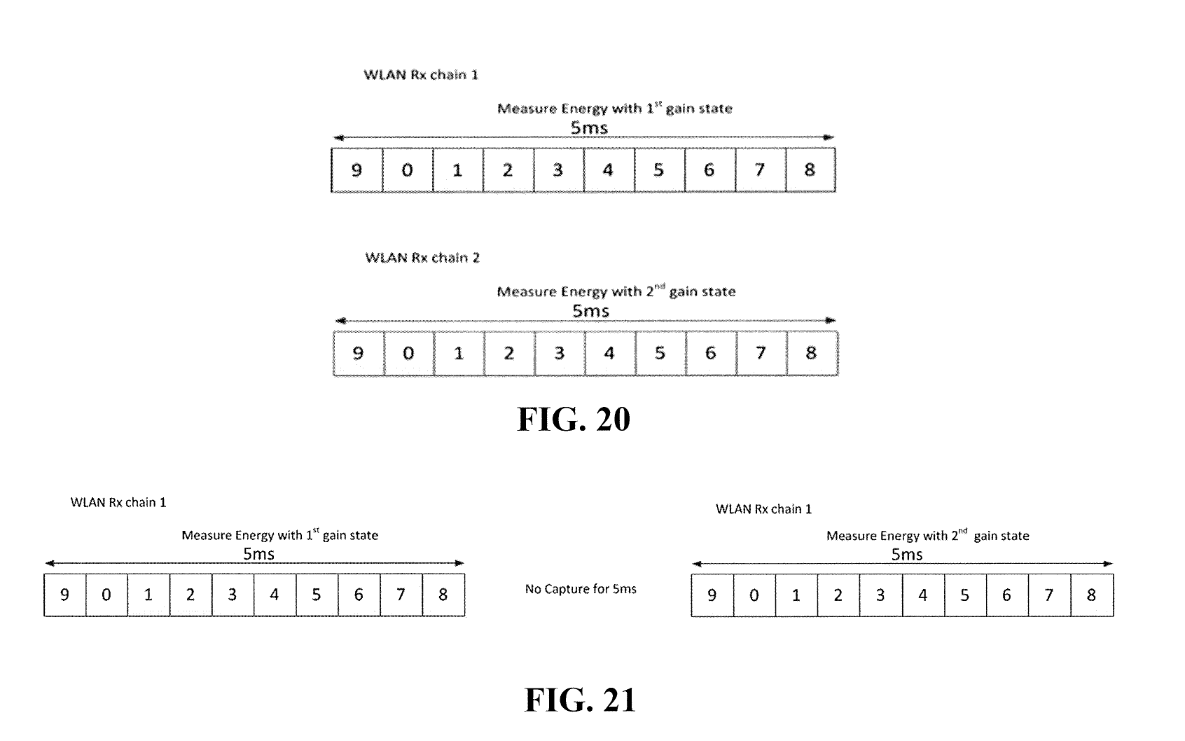

FIGS. 20 and 21 are example depictions of the method of FIG. 19, in cases where the plurality of available gain states may be limited to a discrete set of LNA gain states. For example, in one implementation, the LNA may have only three gain states—G0, G1 and G2 for low, intermediate and high received signal power levels respectively.

In FIG. 20, multiple WLAN receive chains are available. In this case, the UE selects the preferred LNA gain state based on data samples captured by the multiple WLAN receive chains during a single capture period. The preferred LNA gain state is selected by setting the LNA gain state of each of the plurality of WLAN receive chains to a different one of the available LNA gain states, and capturing data samples using each of the plurality of WLAN receive chains for a capture period defined by a plurality of contiguous ticks.

For example, as shown in FIG. 20, if two WLAN receive chains are available, the first WLAN receive chain may be set to gain state G0 and may capture data samples for a capture period, which may be 5.1 ms. The second WLAN receive chain may be set to gain state G1 and may capture data samples for the same capture period. During a next capture period, the first WLAN receive chain may be set to gain state G0 again, while the second WLAN receive chain may be set to gain state G2.

In another example, if three WLAN receive chains are available, the first WLAN receive chain may be set to gain state G0 and may capture data samples for a capture period, which may be 5.1 ms. The second WLAN receive chain may be set to gain state G1 and may capture data samples for the same capture period. The third WLAN receive chain may be set to gain state G2 and may capture data samples for the same period of time.

After the data samples are captured by each of the available WLAN receive chains, the UE obtains a measure for each of the LNA gain states based on data samples captured by the WLAN receive chain having the LNA gain state. The LNA gain state corresponding to the best measure is selected as the preferred LNA gain state. In one configuration, the measure is a signal quality measure. For example, metrics for cell ID detection, e.g. the PSS_SNR and SSS_SNR may be obtained. The respective metrics are compared and the LNA gain state corresponding to highest PSS_SNR and/or SSS_SNR is selected as the LNA gain state. Typically the LNA gain state that results in the highest PSS_SNR also results in the highest SSS_SNR.

In FIG. 21 a single WLAN receive chains is available. In this case, the UE selects a preferred LNA gain state is based on data samples captured by a single WLAN receive chain during a plurality of capture periods. The preferred LNA gain state is selected by setting the LNA gain state of the WLAN receive chain to a first LNA gain state, capturing data samples using the WLAN receive chain for a first capture period defined by a plurality of contiguous ticks, and repeating the setting and capturing for at least one additional LNA gain state.

For example, if a single WLAN receive chain is available, the WLAN receive chain may be set to gain state G0 and may capture data samples for a first capture period, which may be 5.1 ms. After this, the WLAN receive chain may be set to gain state G2 and may capture data samples for a second capture period. Next, the WLAN receive chain may be set to gain state G3 and may capture data samples for a third capture period.

After the data samples are captured by the WLAN receive chain, the UE obtains a measure for each of the LNA gain states based on data samples captured by the WLAN receive chain while set to that LNA gain state. The LNA gain state corresponding to the best measure is selected as the preferred LNA gain state. In one configuration, the measure is a signal quality measure, such as PSS_SNR and SSS_SNR may be obtained.

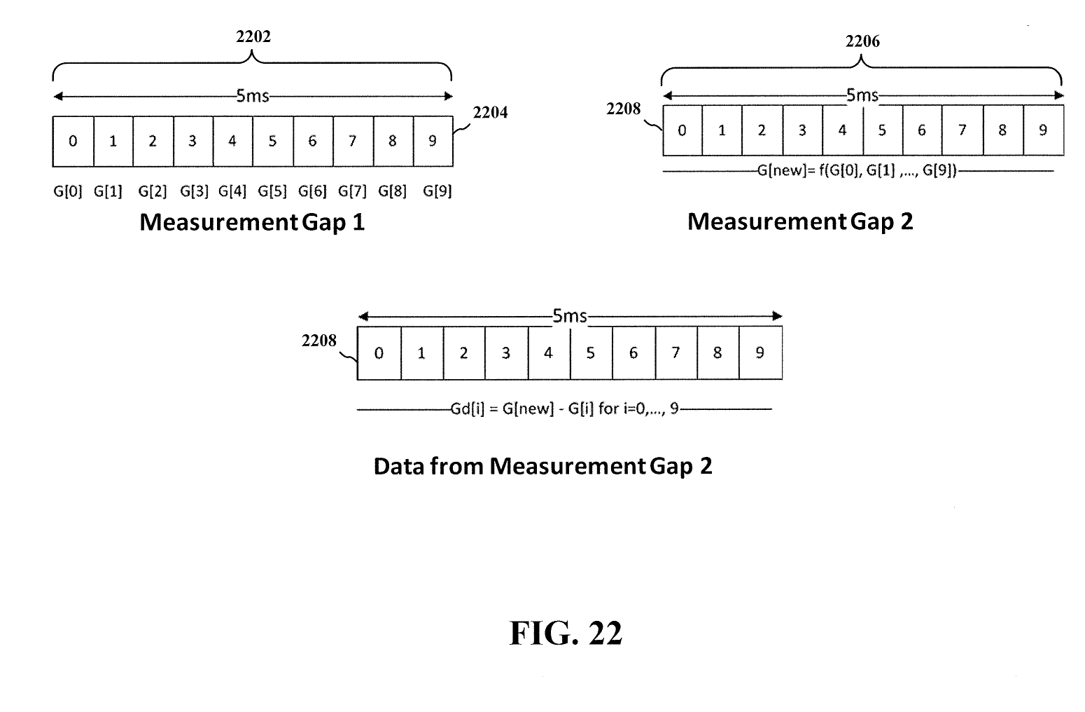

With reference to FIG. 22, in another technique of capturing a signal of interest during a single capture period, data samples are captured using a single LNA gain setting and the results are digitally compensated to adjust for LNA gain. During a measurement period 2202, the LNA gain state is set to a fixed value and samples are acquired for the duration of the measurement period, e.g., 5 ms. The acquired samples are processes to determine an energy measurement for each of a plurality of 0.5 ms measurement ticks 2204 within the measurement period 2202. An LNA gain state for each tick 2204 is determined based on the energy measurement for that tick.

An LNA gain state, G[new], is selected as a function of the gains states (G[0], . . . , G[9]) determined for each of the ticks 2204. In general, G[new] is selected so as to minimize the possibility of signal saturation or losing the received signal in the noise floor. For example, if the minimum gain is selected and the weakest signal during the 5 ms is not lost in the noise floor, then the minimum gain should be used as G[new]. If the maximum gain is selected and the signal is not saturated at any point between the 5 ms, then the maximum gain should be used as G[new]. Given gains G[0], . . . , G[9] , G[new] may be set to G_average, which is a gain close to the mid-point between highest and lowest gain in set G[0]. . . G[9]. In some cases G_average would result in no saturation or losing signal in the noise floor.

Next, during a capture period 2206, the LNA gain state is set to the selected G[new] and samples are acquired for each capture tick 2208 for the duration of the capture period, e.g., 5 ms. The captured samples are then processed by performing a digital gain compensation for each capture tick 2208. The digital gain compensation may be based on the difference between G[new] and each of the optimal LNA gain states G[0], . . . , G[9] determined from the energy measurement for the respective capture ticks 2208.

With this proposal, there may not be a valid LNA gain state where no saturation/lost signal in the noise floor is possible. There are two possible solutions based on this type of application: Allow saturation or recapture the signal. Which solution to apply depends on the application. For example, some applications might be able to tolerate signal saturation, e.g. synchronization signals in LTE would tolerate saturation more than LTE data with 64 QAM. Therefore, if synchronization signals are being decoded, some saturation might be tolerable.

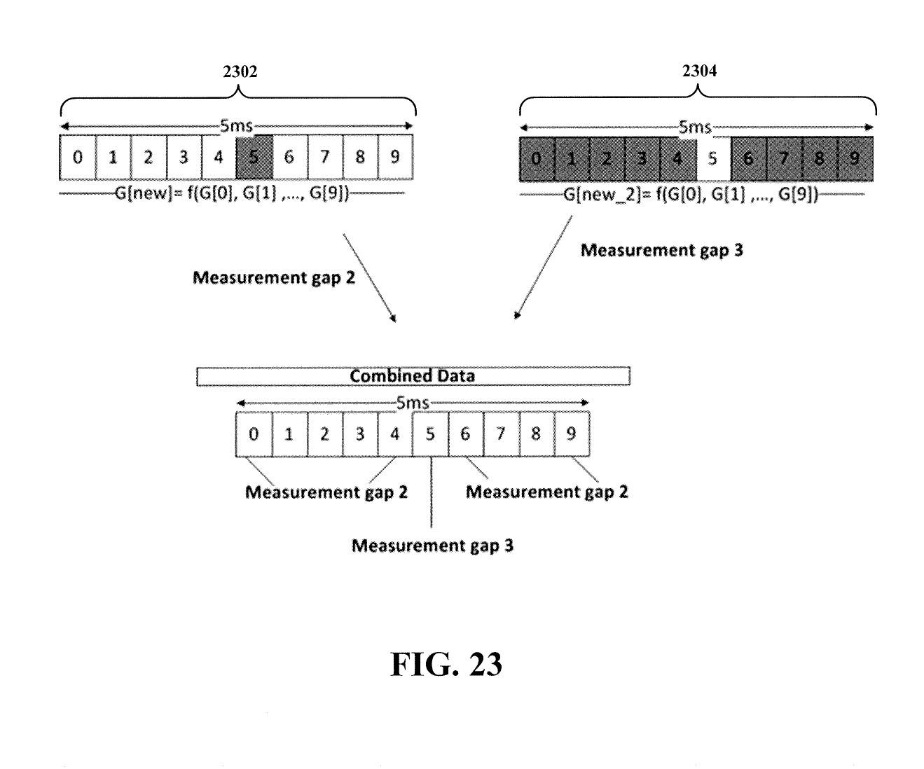

With reference to FIG. 23, if the application being communicated cannot tolerate saturation or the signal being lost in the noise floor with the selected LNA gain G[new], another capture can be initiated with a new LNA gain state, G[new_2]. For example, if the data sample captured during capture tick 5 of a first capture period 2302 is saturated or lost, then a new LNA gain state is selected for a second capture period 2304. The new LNA gain state G[new_2] is selected to ensure the data sample captured during tick 5 is not lost during the next capture period 2304.

Data samples are then captured for each capture tick of the second capture period 2304 using the new LNA gain state. Because the new LNA gain state G[new_2] is selected specifically to ensure capture of data during tick 5, data captured during the other ticks of the second capture period 2304 are likely to be saturated or lost. Digital compensation is then performed on the data captured during the second capture period 2304. The data captured during the first capture period 2302 and during the second capture period 2304 are combined to form continuous data from all capture ticks.

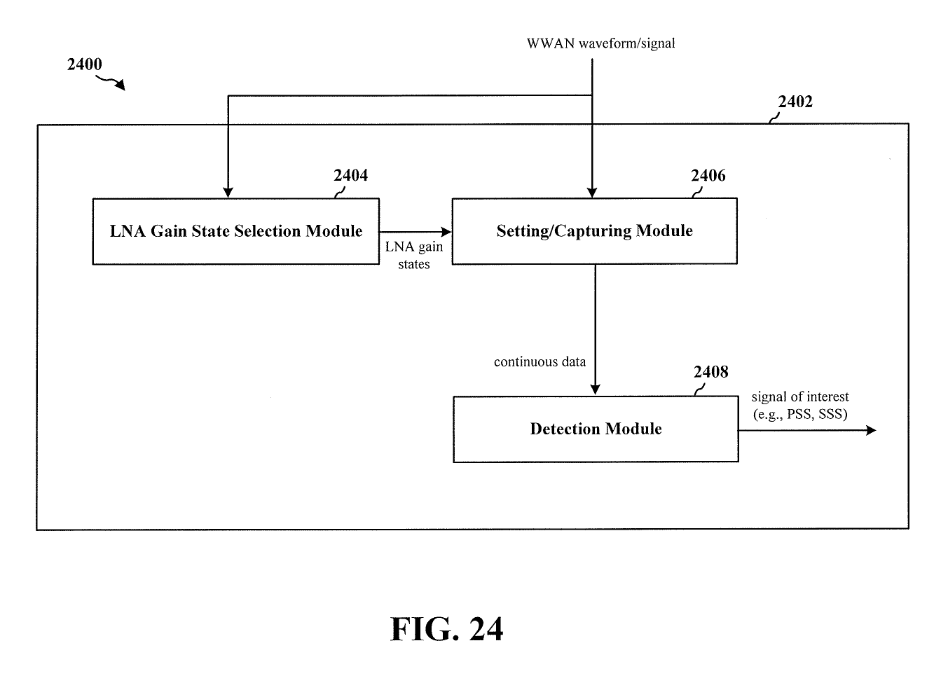

FIG. 24 is a conceptual data flow diagram 2400 illustrating the data flow between different modules/means/components in an exemplary apparatus 2402 for capturing a plurality of data samples during a single capture period using a WLAN receive chain, that include a signal of interest periodically transmitted by a WWAN. The apparatus 2402 may be a UE. The apparatus 2402 includes a LNA gain state selection module 2404, a setting/capturing module 2406, and a detecting module 2408.

The LNA gain state selection module 2404, selects a preferred LNA gain state from among a plurality of available LNA gain states for the WLAN receive chain. The setting/capturing module 2406 sets the LNA gain state of the WLAN receive chain to the selected LNA gain state, and captures data samples during each of a plurality of contiguous capture ticks within a capture period. The detecting module 2408 processes the data samples to detect for the signal of interest.

The apparatus may include additional modules that perform each of the steps of the algorithm in the aforementioned flow chart of FIG. 19 and the diagrams of FIGS. 20-23. As such, each step in the aforementioned flow chart of FIG. 19 and the diagrams of FIGS. 20-23 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof

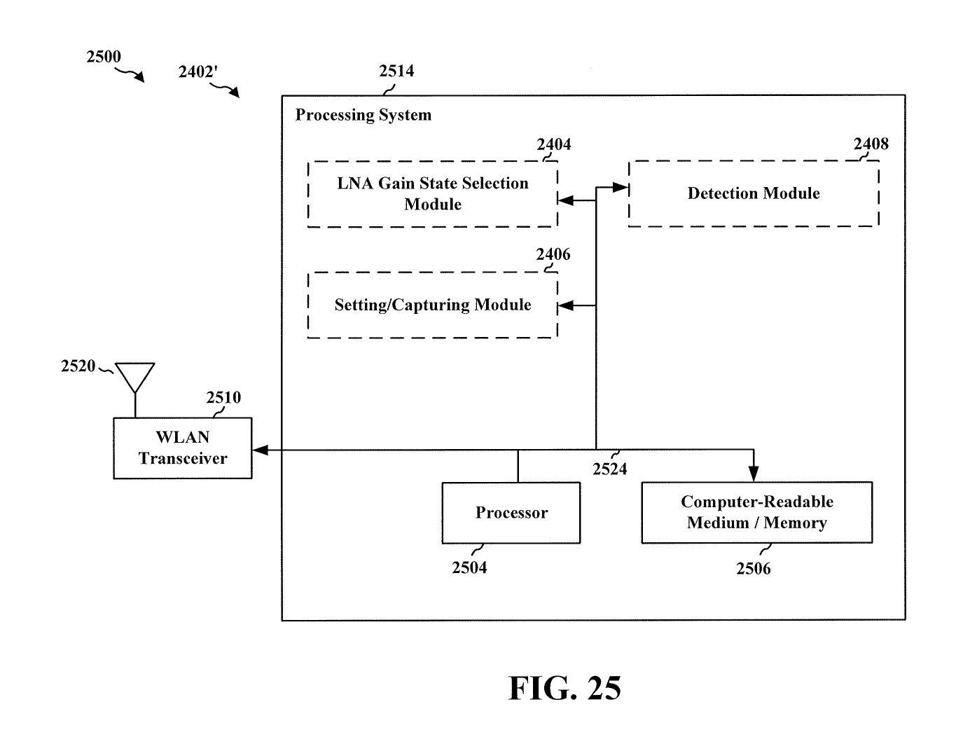

FIG. 25 is a diagram 2500 illustrating an example of a hardware implementation for an apparatus 2502′ employing a processing system 2514. The processing system 2514 may be implemented with a bus architecture, represented generally by the bus 2524. The bus 2524 may include any number of interconnecting buses and bridges depending on the specific application of the processing system 2514 and the overall design constraints. The bus 2524 links together various circuits including one or more processors and/or hardware modules, represented by the processor 2504, the modules 2404, 2406, 2408, and the computer-readable medium/memory 2506. The bus 2524 may also link various other circuits such as timing sources, peripherals, voltage regulators, and power management circuits, which are well known in the art, and therefore, will not be described any further.

The processing system 2514 may be coupled to a WLAN transceiver 2510. The transceiver 2510 is coupled to one or more antennas 2520. The transceiver 2510 provides a means for communicating with various other apparatus over a transmission medium. The transceiver 2510 receives a signal from the one or more antennas 2520, extracts information from the received signal, and provides the extracted information to the processing system 2514. In addition, the transceiver 2510 receives information from the processing system 2514, and based on the received information, generates a signal to be applied to the one or more antennas 2520.

The processing system 2514 includes a processor 2504 coupled to a computer-readable medium/memory 2506. The processor 2504 is responsible for general processing, including the execution of software stored on the computer-readable medium/memory 2506. The software, when executed by the processor 2504, causes the processing system 2514 to perform the various functions described supra for any particular apparatus. The computer-readable medium/memory 2506 may also be used for storing data that is manipulated by the processor 2504 when executing software. The processing system further includes at least one of the modules 2404, 2406, and 2408. The modules may be software modules running in the processor 2504, resident/stored in the computer readable medium/memory 2506, one or more hardware modules coupled to the processor 2504, or some combination thereof The processing system 2514 may be a component of the UE 650 and may include the memory 660 and/or at least one of the TX processor 668, the RX processor 656, and the controller/processor 659.

In one configuration, the apparatus 2402/2402′ for wireless communication includes means for selecting a preferred LNA gain state from among a plurality of available LNA gain states for the WLAN receive chain, means for setting the LNA gain state of the WLAN receive chain to the selected LNA gain state, means for capturing data samples during each of a plurality of contiguous capture ticks within a capture period, and means for processing the data samples to detect for the signal of interest.

The aforementioned means may be one or more of the aforementioned modules of the apparatus 2402 and/or the processing system 2414 of the apparatus 2402′ configured to perform the functions recited by the aforementioned means. As described supra, the processing system 2414 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

It is understood that the specific order or hierarchy of steps in the processes/flow charts disclosed is an illustration of exemplary approaches. Based upon design preferences, it is understood that the specific order or hierarchy of steps in the processes/flow charts may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of capturing a plurality of data samples over a plurality of capture periods to form continuous data including a signal of interest periodically transmitted by a wireless wide area network (WWAN), said method comprising:
for a first capture period defined by a plurality of contiguous ticks, capturing data samples during a first set of capture ticks, wherein:
the first set of capture ticks comprises a first subset of the plurality of contiguous ticks, and
the capturing is done using a wireless local area network (WLAN) receive chain having a switchable LNA gain state; and
repeating the capturing for at least one additional capture period defined by a plurality of contiguous ticks in order to capture data samples during at least one additional set of capture ticks comprising an additional subset of the plurality of contiguous ticks for which data samples were not previously captured,
wherein the LNA gain state is switched at least once over the plurality of capture periods.

2. The method of claim 1, further comprising determining the LNA gain state for each of the plurality of contiguous ticks.

3. The method of claim 1, further comprising processing the captured data samples to form the continuous data.

4. The method of claim 1, wherein the LNA gain state of the WLAN receive chain is switched during a no capture tick of at least one of the plurality of capture periods.

5. The method of claim 4, wherein each of the capture ticks has an associated LNA gain state and the LNA gain state of the WLAN receive chain is switched during a no capture period to correspond to the LNA gain state of the next capture tick in the set of capture ticks.

6. The method claim 4, wherein the first set of capture ticks and the at least one additional set of capture ticks are characterized by a same pattern of ticks.

7. The method of claim 6, wherein the same pattern of ticks comprises one of: every other tick within the plurality of contiguous ticks, every third tick within the plurality of contiguous ticks, and every fourth tick within the plurality of contiguous ticks.

8. The method of claim 7, wherein the same pattern is a function of the switch time of the LNA gain state.

9. The method of claim 4 further comprising delaying the repeating of the capturing for a delay time based on the capture period and the periodicity of transmission of the signal of interest.

10. The method of claim 9, wherein, in the case of a capture period of 5 ms and a periodicity of 5 ms, the delay time is 1 ms.

11. The method of claim 10, wherein the signal of interest comprises each of PSS and SSS, and further comprising:
determining if SSS lies completely within any of the capture data samples; and
detecting SSS using the continuum of data if SSS lies completely within any of the capture data samples

12. The method of claim 4, further comprising:
increasing each capture tick by 1 OFDM symbol; and
decreasing each no capture tick by 1 OFDM

13. The method of claim 1, wherein:
the LNA gain state of the WLAN receive chain is set to a first LNA gain state for the first capture period, the first LNA gain state corresponding to one of a plurality of LNA gain states derived for the plurality of contiguous ticks, and
the LNA gain state of the WLAN receive chain is switched to another LNA gain state corresponding to one of the plurality of LNA gain states, during a delay time between two of the plurality of capture periods.

14. An apparatus for capturing a plurality of data samples over a plurality of capture periods to form continuous data including a signal of interest periodically transmitted by a wireless wide area network (WWAN), said apparatus comprising:
means for capturing, for a first capture period defined by a plurality of contiguous ticks, data samples during a first set of capture ticks, wherein:
the first set of capture ticks comprises a first subset of the plurality of contiguous ticks, and
the capturing is done using a wireless local area network (WLAN) receive chain having a switchable LNA gain state; and
means for repeating the capturing for at least one additional capture period defined by a plurality of contiguous ticks in order to capture data samples during at least one additional set of capture ticks comprising an additional subset of the plurality of contiguous ticks for which data samples were not previously captured,
wherein the LNA gain state is switched at least once over the plurality of capture periods.

15. The apparatus of claim 14, further comprising means for determining the LNA gain state for each of the plurality of contiguous ticks.

16. The apparatus of claim 14, further comprising means for processing the captured data samples to form the continuous data.

17. The apparatus of claim 14, wherein the LNA gain state of the WLAN receive chain is switched during a no capture tick of at least one of the plurality of capture periods.

18. The apparatus of claim 17, wherein each of the capture ticks has an associated LNA gain state and the LNA gain state of the WLAN receive chain is switched during a no capture period to correspond to the LNA gain state of the next capture tick in the set of capture ticks.

19. The apparatus claim 17, wherein the first set of capture ticks and the at least one additional set of capture ticks are characterized by a same pattern of ticks.

20. The apparatus of claim 19, wherein the same pattern of ticks comprises one of:
every other tick within the plurality of contiguous ticks, every third tick within the plurality of contiguous ticks, and every fourth tick within the plurality of contiguous ticks.

21. The apparatus of claim 20, wherein the same pattern is a function of the switch time of the LNA gain state.

22. The apparatus of claim 17 further comprising means for delaying the repeating of the capturing for a delay time based on the capture period and the periodicity of transmission of the signal of interest.

23. The apparatus of claim 22, wherein, in the case of a capture period of 5 ms and a periodicity of 5 ms, the delay time is 1 ms.

24. The apparatus of claim 23, wherein the signal of interest comprises each of PSS and SSS, and further comprising:
means for determining if SSS lies completely within any of the capture data samples; and
means for detecting SSS using the continuum of data if SSS lies completely within any of the capture data samples

25. The apparatus of claim 17, further comprising:
means for increasing each capture tick by 1 OFDM symbol; and
means for decreasing each no capture tick by 1 OFDM

26. The apparatus of claim 14, wherein:
the LNA gain state of the WLAN receive chain is set to a first LNA gain state for the first capture period, the first LNA gain state corresponding to one of a plurality of LNA gain states derived for the plurality of contiguous ticks, and
the LNA gain state of the WLAN receive chain is switched to another LNA gain state corresponding to one of the plurality of LNA gain states, during a delay time between two of the plurality of capture periods.

27. An apparatus for capturing a plurality of data samples over a plurality of capture periods to form continuous data including a signal of interest periodically transmitted by a wireless wide area network (WWAN), said apparatus comprising:
a memory; and
at least one processor coupled to the memory and configured to:
capture data samples, for a first capture period defined by a plurality of contiguous ticks, during a first set of capture ticks, wherein:
the first set of capture ticks comprises a first subset of the plurality of contiguous ticks, and
the capturing is done using a wireless local area network (WLAN) receive chain having a switchable LNA gain state; and
repeat the capturing for at least one additional capture period defined by a plurality of contiguous ticks in order to capture data samples during at least one additional set of capture ticks comprising an additional subset of the plurality of contiguous ticks for which data samples were not previously captured,
wherein the LNA gain state is switched at least once over the plurality of capture periods.

28. The apparatus of claim 27, wherein the at least one processor is further configured to determine the LNA gain state for each of the plurality of contiguous ticks.

29. The apparatus of claim 27, wherein the at least one processor is further configured to process the captured data samples to form the continuous data.

30. A computer program product for capturing a plurality of data samples over a plurality of capture periods to form continuous data including a signal of interest periodically transmitted by a wireless wide area network (WWAN), said product stored on a computer-readable medium and comprising code that when executed on at least one processor performs the steps of:
for a first capture period defined by a plurality of contiguous ticks, capturing data samples during a first set of capture ticks, wherein:
the first set of capture ticks comprises a first subset of the plurality of contiguous ticks, and
the capturing is done using a wireless local area network (WLAN) receive chain having a switchable LNA gain state; and
repeating the capturing for at least one additional capture period defined by a plurality of contiguous ticks in order to capture data samples during at least one additional set of capture ticks comprising an additional subset of the plurality of contiguous ticks for which data samples were not previously captured,
wherein the LNA gain state is switched at least once over the plurality of capture periods.
